(19) United States
(12) Patent Application Publication
(10) Pub. No.: US 2026/0161234 A1
(43) Pub. Date: Jun. 11, 2026

(54) INFORMATION PROCESSING APPARATUS

(71) Applicant: CANON KABUSHIKI KAISHA, Tokyo (JP)

(72) Inventors: NAOTO OKUMURA, Kanagawa (JP); TOSHIHIRO MOCHIZUKI, Kanagawa (JP)

(21) Appl. No.: 19/389,697

(22) Filed: Nov. 14, 2025

(30) Foreign Application Priority Data
Dec. 11, 2024 (JP) 2024-216248

(51) Int. Cl. G06F 3/01; G06T 7/70

(52) U.S. Cl. CPC G06F 3/016; G06F 3/011; G06T 7/70; G06T 2207/30196

(57) ABSTRACT

An information processing apparatus according to the present disclosure includes a processor, and a memory storing a program which, when executed by the processor, causes the information processing apparatus to execute acquisition processing of acquiring information of a position and an orientation of a user for each of a plurality of users, and execute control processing of controlling display of a virtual space on a basis of a plurality of information respectively corresponding to the plurality of users acquired by the acquisition processing such that touches corresponding to haptic sensations that are not simultaneously presentable to two or more users from a haptic device to be used do not occur as the touches of the two or more users with a virtual object in the virtual space.

### BACKGROUND

### Field of the Technology

The present disclosure relates to an information processing apparatus, and more particularly, to a technology for presenting a haptic sensation in a virtual space to a user.

### Description of the Related Art

Japanese Patent Laid-Open No. 2019-525344 discloses aerial haptic sensation feedback (aerial haptics) using a continuous distribution of sound energy called a “sound field”. By using the aerial haptics, a user can obtain a haptic sensation related to a virtual space such as an augmented reality (AR) space or a mixed reality (MR) space without wearing a haptic glove or the like.

However, in the aerial haptics, the sound field changes due to interference between the user and an ultrasonic wave from a haptic device. Thus, in a case where a user A and a user B share one sound field, a haptic sensation obtained by the user A changes (for example, the haptic sensation obtained by the user A deviates from a haptic sensation imagined by the user A) due to interference between the user B and the ultrasonic wave, and the user may feel a sense of discomfort.

### SUMMARY

The present disclosure provides a technology capable of suppressing presentation of a haptic sensation with a sense of discomfort.

The present disclosure in its first aspect provides an information processing apparatus including a processor, and a memory storing a program which, when executed by the processor, causes the information processing apparatus to execute acquisition processing of acquiring information of a position and an orientation of a user for each of a plurality of users, and execute control processing of controlling display of a virtual space on a basis of a plurality of information respectively corresponding to the plurality of users acquired by the acquisition processing such that touches corresponding to haptic sensations that are not simultaneously presentable to two or more users from a haptic device to be used do not occur as the touches of the two or more users with a virtual object in the virtual space.

The present disclosure in its second aspect provides an information processing method including processing of acquiring information of a position and an orientation of a user for each of a plurality of users, and controlling display of a virtual space on a basis of a plurality of acquired information respectively corresponding to the plurality of users such that touches corresponding to haptic sensations that are not simultaneously presentable to two or more users from a haptic device to be used do not occur as the touches of the two or more users with a virtual object in the virtual space.

The present disclosure in its third aspect provides a non-transitory computer readable medium that stores a program, wherein the program causes a computer to execute an information processing method including processing of acquiring information of a position and an orientation of a user for each of a plurality of users, and controlling display of a virtual space on a basis of a plurality of acquired information respectively corresponding to the plurality of users such that touches corresponding to haptic sensations that are not simultaneously presentable to two or more users from a haptic device to be used do not occur as the touches of the two or more users with a virtual object in the virtual space.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of a display system according to a first embodiment.

FIG. 2 is an external view of a display device.

FIG. 3 is a schematic diagram of a haptic sensation generation unit.

FIG. 4 is a flowchart of aerial haptics processing according to the first embodiment.

FIGS. 5A, 5C, and 5E are schematic diagrams of a use state of the display system.

FIGS. 5B, 5D, 5F, and 5G are schematic diagrams of a combined image.

FIGS. 6A to 6D are schematic diagrams of processing in step S415.

FIG. 7 is a flowchart of processing of step S416.

FIG. 8 is a block diagram of a display system according to a second embodiment.

FIG. 9 is a flowchart of aerial haptics processing according to the second embodiment.

### DESCRIPTION OF THE EMBODIMENTS

### First Embodiment

A first embodiment of the present disclosure will be described.

### System Configuration

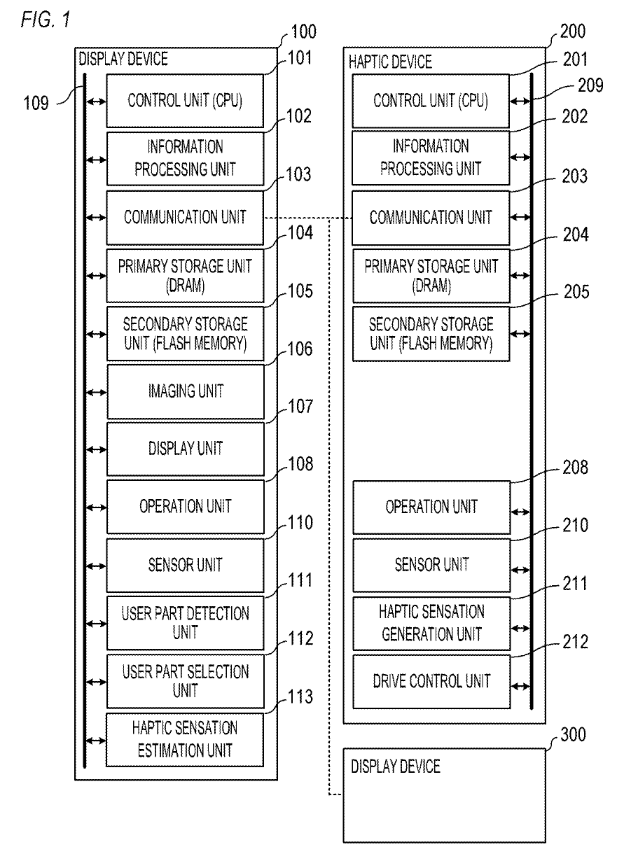

FIG. 1 is a block diagram illustrating a configuration of a display system according to the first embodiment. The display system in FIG. 1 includes display devices 100 and 300 and a haptic device 200 (haptic sensation generation device). Note that, the number of display devices may be more than two. The number of haptic devices may also be more than one.

### Display Device

As illustrated in FIG. 1, the display device 100 includes a control unit 101, an information processing unit 102, a communication unit 103, a primary storage unit 104, a secondary storage unit 105, an imaging unit 106, a display unit 107, and an operation unit 108. Further, the display device 100 includes a sensor unit 110, a user part detection unit 111, a user part selection unit 112, and a haptic sensation estimation unit 113. These components are connected to a bus 109, and data is transmitted and received between the components via the bus 109. In the description of the display device 100, it is assumed that a user is a user of the display device 100. Since a configuration of the display device 300 is similar to a configuration of the display device 100, the description of the display device 300 is omitted.

The control unit 101 is, for example, a CPU, and controls each unit of the display device 100.

The information processing unit 102 is a processing circuit (arithmetic unit) that performs various types of information processing (arithmetic processing) such as four arithmetic operations, matrix arithmetic operations, and physical arithmetic operations. For example, the information processing unit 102 performs arithmetic processing of image data obtained by the imaging unit 106 (arithmetic processing of obtaining various evaluation values regarding the image data, and the like), arithmetic processing of data acquired by the communication unit 103, and the like.

The communication unit 103 is a communication interface that performs communication with an external device.

The primary storage unit 104 is, for example, a DRAM and temporarily stores data used by the control unit 101 and the information processing unit 102.

The secondary storage unit 105 is, for example, a flash memory and stores data used by the control unit 101 and the information processing unit 102, a processing result (for example, an encoded recorded image) of the information processing unit 102, and the like.

The imaging unit 106 includes, for example, an optical lens, an imaging element (image sensor), and an A/D converter and converts light from the outside (object) into digital data (image data).

The display unit 107 is a display that displays various images. The display unit 107 may have a touch panel that receives a touch operation with a user's finger, a stylus, or the like. The display unit 107 provides a virtual space such as an augmented reality (AR) space or a mixed reality (MR) space to a user. In the virtual space, the user can touch a virtual object. A position and an orientation of the user in the virtual space are linked to a position and an orientation of the user in a real space. As the user in the virtual space, an image obtained by imaging (capturing) the user may be displayed, or a three-dimensional model (CG) corresponding to the user may be displayed. In a case where the display device 100 is an optical see-through type display device, the user in the virtual space may be the user themselves in the real space.

The operation unit 108 includes an operation member that receives a user operation and includes, for example, a button and a dial. The above-described touch panel is also an example of the operation member. When a user operation is performed on the operation members, the control unit 101 performs control in response to the user operation. The communication unit 103 may acquire a signal in response to a user operation on the external device, and the control unit 101 may perform control in accordance with a signal.

The sensor unit 110 includes various sensors. For example, the sensor unit 110 includes a gyro sensor, an acceleration sensor, and a global positioning system (GPS) sensor, and acquires information of an angular velocity and a current position of the display device 100. The information of the angular velocity and the current position of the display device 100 may be acquired in a method different from a method using the gyro sensor, the acceleration sensor, and the GPS sensor.

The user part detection unit 111 detects the user from the real space and acquires the information of the position and orientation (posture) of the user. A method for detecting the user and a method for acquiring the information of the position and the orientation of the user are not particularly limited, but in the first embodiment, the user part detection unit 111 detects the user from image data (image obtained by imaging the real space) obtained by the imaging unit 106. More specifically, the user part detection unit 111 detects one or more user parts (parts of the user) from the image data obtained by the imaging unit 106, and acquires information on a position and an orientation of the detected user part. A method for detecting the user part (user) is not particularly limited, and the user part may be detected by, for example, feature extraction processing using a convolutional neural network (CNN). Various user parts can be detected by switching weights in the CNN. For example, a hand, a finger, an arm, a face, and the like can be detected. In the first embodiment, the hand is detected, but a detection target is not limited to the hand, and may be a finger, an arm, a face, or the like.

The user part selection unit 112 selects the user part detected by the user part detection unit 111, as a user part to which a haptic sensation is to be presented. In the first embodiment, in a case where one user part is detected by the user part detection unit 111, the user part is selected. In a case where a plurality of user parts are detected by the user part detection unit 111, one of the plurality of user parts is selected. In the first embodiment, one hand is selected, but a selection target is not limited to the hand, and may be a finger, an arm, a face, or the like. A plurality of user parts may be selected. A method for selecting the user part is not particularly limited. For example, the user part detection unit 111 stores information of the detected user part in the primary storage unit 104, and the display unit 107 displays a detection result of the user part on the basis of the information. The user performs a user operation of designating the detected user part by using the operation unit 108, and the user part selection unit 112 selects the designated user part in accordance with the user operation.

The haptic sensation estimation unit 113 estimates a haptic sensation corresponding to the touch of the user part with the virtual object. Here, the user part is a user part selected by the user part selection unit 112. In the first embodiment, it is assumed that the haptic sensation estimation unit 123 estimates a haptic sensation intensity corresponding to the touch of the user part with the virtual object by performing interference simulation by physical arithmetic operation. The following data and information are used for interference simulation. Information other than the information acquired by the user part detection unit 111 may be stored in advance in the primary storage unit 104 or may be acquired from an outside by the communication unit 103.

Data of three-dimensional model of user part

Information acquired by user part detection unit 111 (information of position and orientation of user part)

Data of three-dimensional model of virtual object

Information of position and orientation of virtual object

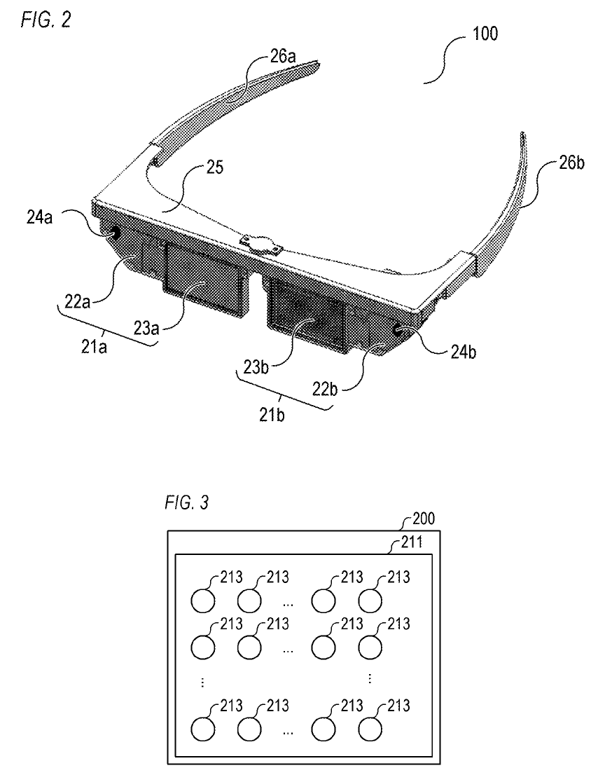

FIG. 2 is an external view of the display device 100. The display device 100 is a video see-through type display device, and includes a frame, two display units 21a and 21b corresponding to the display unit 107, and two imaging units 24a and 24b corresponding to the imaging unit 106. The frame includes a rim 25 having a lower surface to which the display units 21a and 21b are bonded, and temples 26a and 26b bonded to both sides of the rim 25. The imaging units 24a and 24b image a front side (real space) of the display device 100. In the display unit 21a, light from a display element (not illustrated) is guided to a right eye of the user wearing the display device 100 by an image projection unit 22a and a light guide unit 23a. The light guided to the right eye of the user represents, for example, an image with an image (image of the real space) imaged by the imaging unit 24a as a background. Similarly, in the display unit 21b, light from a display element (not illustrated) is guided to a left eye of the user wearing the display device 100 by an image projection unit 22b and a light guide unit 23b. The light guided to the left eye of the user represents, for example, an image with an image (image of the real space) imaged by the imaging unit 24b as a background. Note that, the optical see-through type display device may be used as the display device 100. In the case of the optical see-through type display device, the display device 100 may not include the imaging units 24a and 24b. The user can visually recognize the front side of the display device 100 (the real space itself that is not the image) via the display units 21a and 21b. The user can visually recognize a video displayed on the display units 21a and 21b and the front side of the display device 100 at the same time.

### Haptic Device

As illustrated in FIG. 1, the haptic device 200 includes a control unit 201, an information processing unit 202, a communication unit 203, a primary storage unit 204, a secondary storage unit 205, an operation unit 208, a sensor unit 210, a haptic sensation generation unit 211, and a drive control unit 212. These components are connected to a bus 209, and data is transmitted and received between the components via the bus 209. In the description of the haptic device 200, it is assumed that users are a user of the display device 100 and a user of the display device 300.

The control unit 201 is, for example, a CPU, and controls each unit of the haptic device 200.

The information processing unit 202 is a processing circuit (arithmetic unit) that performs various types of information processing (arithmetic processing) such as four arithmetic operations, matrix arithmetic operations, and physical arithmetic operations. For example, the information processing unit 202 performs arithmetic processing or the like of data acquired by the communication unit 203.

The communication unit 203 is a communication interface that performs communication with an external device.

The primary storage unit 204 is, for example, a DRAM and temporarily stores data used by the control unit 201 and the information processing unit 202.

The secondary storage unit 205 is, for example, a flash memory and stores data used by the control unit 201 and the information processing unit 202, a processing result of the information processing unit 202, and the like.

The operation unit 208 includes an operation member that receives a user operation and includes, for example, a button and a dial. When a user operation is performed on the operation members, the control unit 201 performs control in response to the user operation. The communication unit 203 may acquire a signal in response to a user operation on the external device, and the control unit 201 may perform control in accordance with a signal.

The sensor unit 210 includes various sensors. For example, the sensor unit 210 includes a gyro sensor, an acceleration sensor, and a GPS sensor, and acquires information of an angular velocity and a current position of the haptic device 200. The information of the angular velocity and the current position of the haptic device 200 may be acquired in a method different from a method using the gyro sensor, the acceleration sensor, and the GPS sensor.

The haptic sensation generation unit 211 outputs an ultrasonic wave for presenting a haptic sensation to the user.

The drive control unit 212 drives the haptic sensation generation unit 211 (haptics driver 213 to be described later) in accordance with a haptic sensation signal received by the communication unit 203. The haptic sensation signal includes frequency information, intensity information, positional information, and synchronization information. The drive control unit 212 drives the haptic sensation generation unit 211 such that the following haptic sensation presentation is performed.

In accordance with a haptic sensation signal received from the display device 100, an ultrasonic wave having a frequency indicated by the frequency information and an intensity indicated by the intensity information reaches a position indicated by the positional information, and the haptic sensation is presented in synchronization with the display on the display device 100.

In accordance with a haptic sensation signal received from the display device 300, an ultrasonic wave having a frequency indicated by the frequency information and an intensity indicated by the intensity information reaches a position indicated by the positional information, and the haptic sensation is presented in synchronization with the display on the display device 100.

FIG. 3 is a schematic diagram illustrating a configuration of the haptic sensation generation unit 211. The haptic sensation generation unit 211 includes a plurality of haptics drivers 213 arrayed two-dimensionally. The haptics driver 213 is, for example, an ultrasonic transducer. The vibration of each haptics driver 213 is individually controlled, and thus, a desired haptic sensation can be expressed.

### Communication between Display Device and Haptic Device

Communication between the display device 100 and the haptic device 200 is performed by using the communication unit 103 and the communication unit 203. The display device 100 transmits a haptic sensation reproduction signal request to the haptic device 200. When the haptic sensation reproduction signal request is received from the display device 100, the haptic device 200 transmits a haptic sensation reproduction signal to the display device 100. Further, the display device 100 and the haptic device 200 transmit and receive pieces of information acquired by the sensor units 110 and 210 to and from each other.

The haptic sensation reproduction signal request is a signal requesting the haptic sensation reproduction signal. The haptic sensation reproduction signal is a signal indicating information of the haptic device, and is, for example, a signal indicating a haptic sensation that is presentable from the haptic device 200 to the user. In the first embodiment, the haptic sensation reproduction signal indicates frequency range information, intensity range information, and region information for each type of haptic sensation, such as “warm”, “cold”, “hard”, “soft”, “smooth”, and “rough”. The region information indicates a three-dimensional region in which a haptic sensation is presentable to the user. The frequency range information indicates, for each position within a region indicated by the region information, a range (upper limit and lower limit) of a frequency of the ultrasonic wave corresponding to the haptic sensation that is presentable to the user. The intensity range information indicates, for each position within a region indicated by the region information, a range (upper limit and lower limit) of intensity of the ultrasonic wave corresponding to the haptic sensation that is presentable to the user.

When the haptic sensation to be presented to the user of the display device 100 is determined, the display device 100 transmits the haptic sensation signal to the haptic device 200. When the haptic sensation signal is received from the display device 100, the haptic device 200 presents the haptic sensation to the user of the display device 100 by driving each haptics driver 213 according to the haptic sensation signal. The display device 100 may communicate with a plurality of haptic devices, and the haptic sensation determined by the display device 100 may be presented to the user of the display device 100 by ultrasonic waves from the plurality of haptic devices.

Communication between the display device 300 and the haptic device 200 is similar to the communication between the display device 100 and the haptic device 200, and the haptic device 200 presents the haptic sensation to the user of the display device 300 according to the haptic sensation signal from the display device 300.

### Aerial Haptics Processing

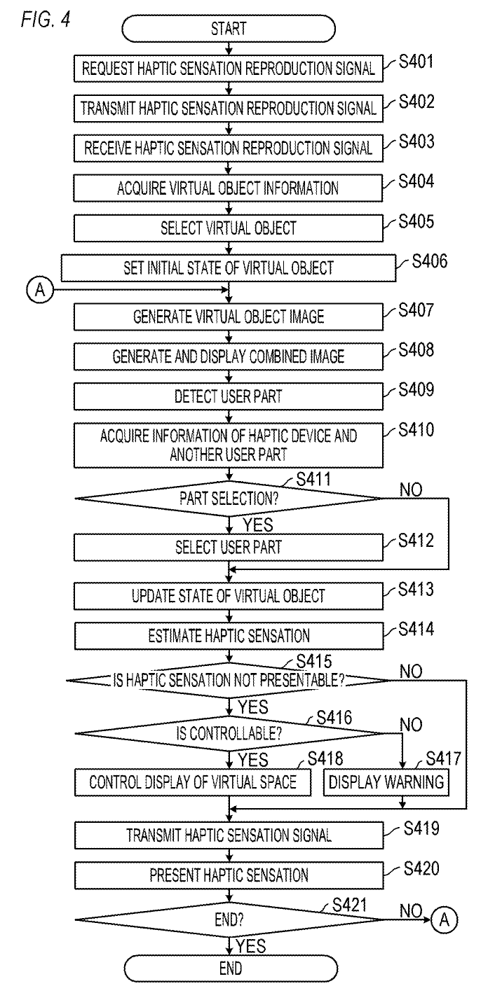

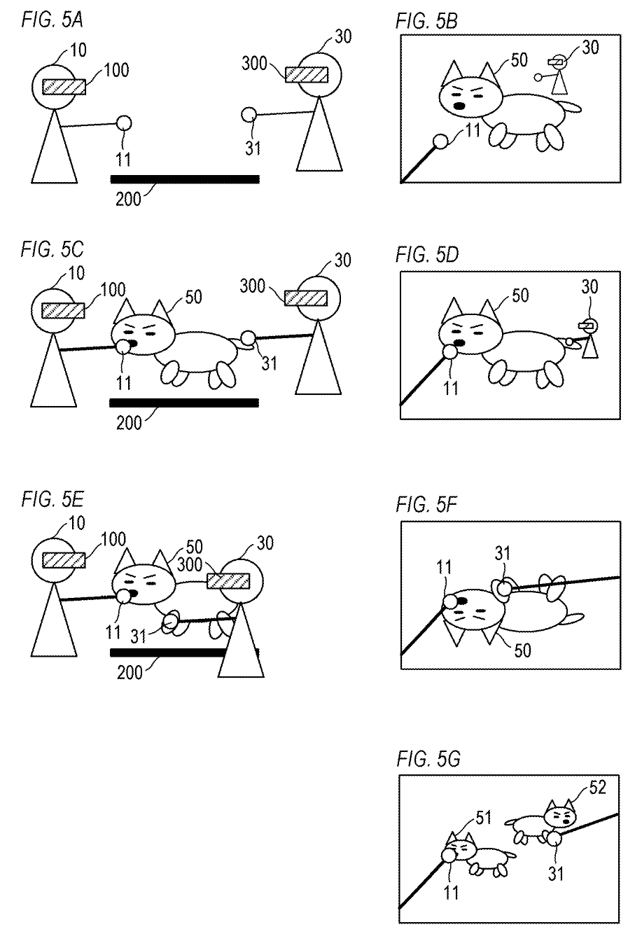

FIG. 4 is a flowchart of aerial haptics processing performed by the display system according to the first embodiment. For example, when the display devices 100 and 300 and the haptic device 200 are activated, the display devices 100 and 300 execute applications for providing the virtual space to the user, or the like, and the connection between the display devices 100 and 300 and the haptic device 200 is established, the aerial haptics processing of FIG. 4 is started. When the aerial haptics processing of FIG. 4 is executed, as illustrated in FIG. 5A, the haptic device 200 is arranged in the vicinity of a user 10 of the display device 100 and a user 30 of the display device 300. Then, the user 10 wears the display device 100 on the head, and the user 30 wears the display device 300 on the head. Note that, although description of processing of the display device 300 will be omitted below, processing similar to that of the display device 100 is also performed in the display device 300.

In step S401, the control unit 101 of the display device 100 transmits the haptic sensation reproduction signal request to the haptic device 200 via the communication unit 103.

In step S402, the control unit 201 of the haptic device 200 receives the haptic sensation reproduction signal request from the display device 100 via the communication unit 203, and transmits the haptic sensation reproduction signal to the display device 100 via the communication unit 203.

In step S403, the control unit 101 receives the haptic sensation reproduction signal from the haptic device 200 via the communication unit 103, and stores the received haptic sensation reproduction signal in the secondary storage unit 105.

In step S404, the control unit 101 acquires virtual object information indicating a three-dimensional model, a material, a mass, a behavior pattern, and the like of the virtual object from a database (not illustrated) on a cloud via the communication unit 103. The virtual object information may be stored in the secondary storage unit 105 in advance.

In step S405, the control unit 101 selects one or more virtual objects from a plurality of virtual objects indicated by the virtual object information acquired in step S404. A method for selecting the virtual object is not particularly limited. For example, the control unit 101 displays a list of the plurality of virtual objects indicated by the virtual object information on the display unit 107, and selects a designated virtual object in accordance with a user operation of designating one or more virtual objects by using the operation unit 108. The control unit 101 may automatically select the virtual object in accordance with an area of the virtual space visually recognized by the user 10. In the first embodiment, it is assumed that a common (same) virtual object is selected between the display device 100 and the display device 300.

In step S406, the control unit 101 sets an initial state on the basis of the information of the virtual object acquired in step S404, as a state (position, orientation, shape, behavior, light source, or the like) of the virtual object selected in step S405.

In step S407, the control unit 101 controls the information processing unit 102 on the basis of the set state of the virtual object, and generates a virtual object image corresponding to the position and orientation of the user 10 (display device 100). A method for generating the virtual object image is not particularly limited. For example, a two-dimensional virtual object image is generated by arranging a three-dimensional model of the virtual object in the virtual space in a state of the virtual object being set and performing coordinate deformation, geometric deformation, or the like in accordance with the position and orientation of the user 10 (display device 100).

In step S408, the control unit 101 controls the information processing unit 102 to combine (superimpose) the virtual object image generated in step S407 with the image (real space image obtained by imaging the real space) obtained by the imaging unit 106. As a result, a combined image obtained by combining the virtual object image with the real space image is generated. Then, the control unit 101 displays the combined image on the display unit 107. FIG. 5B is a schematic diagram illustrating an example of the combined image. In the combined image of FIG. 5B, a hand 11 of the user 10, the user 30, and a dog 50 of the virtual object are displayed.

In step S409, the control unit 101 controls the user part detection unit 111 to detect a position and an orientation of the hand 11 of the user 10 from the real space image.

In step S410, the control unit 101 acquires information of a position and an orientation of a hand 31 of the user 30 from the display device 300 via the communication unit 103. In addition, the control unit 101 acquires information on a position and an orientation of the haptic device 200 from the haptic device 200 via the communication unit 103. Note that, a method for acquiring these pieces of information is not particularly limited. These pieces of information may not be acquired from an outside of display device 100. These pieces of information may be generated inside the display device 100 by detecting the hand 31 and the haptic device 200 from the real space image.

In step S411, the control unit 101 determines whether or not to perform the user part selection. The processing proceeds to step S412 in a case where the user part selection is performed, and otherwise, the processing proceeds to step S413. For example, when the user 10 gives an instruction about the execution of the user part selection on a menu screen by using the operation unit 108, the user part selection is performed. In step S409, an unnecessary hand such as the hand 31 of the user 30 or the other hand (hand different from the hand 11) of the user 10 may be detected. In such a case, the user 10 gives an instruction about the execution of the user part selection in order to select the necessary hand 11.

In step S412, the control unit 101 controls the user part selection unit 112 to select the hand 11.

In step S413, the control unit 101 updates the set state of the virtual object on the basis of a behavior pattern of the virtual object.

In step S414, the control unit 101 controls the haptic sensation estimation unit 113 to estimate the haptic sensation corresponding to the touch of the user 10 (hand 11) with the virtual object. For example, the haptic sensation is estimated by interference simulation on the basis of the position and orientation of the hand 11 detected in step S409 and a state of the virtual object updated in step S413.

In step S415, the control unit 101 determines whether or not touches corresponding to haptic sensations that are not simultaneously presentable from the haptic device 200 to the users 10 and 30 (hands 11 and 31) occur as the touches of the users 10 and 30 with the virtual object. In this determination, the position and orientation of the hand 11, the position and orientation of the hand 31, the position and orientation of the haptic device 200, and the like are considered. The haptic sensation estimated for the hand 11 (intensity of the haptic sensation, intensity of the ultrasonic wave, frequency of the ultrasonic wave, or the like), the haptic sensation estimated for the hand 31, and the like may also be considered. In a case where the touch corresponding to the haptic sensation that is not presentable occurs, the processing proceeds to step S416, and otherwise, the processing proceeds to step S419. Details of this determination will be described later. In the first embodiment, the display of the virtual space is controlled such that the touch corresponding to the haptic sensation that is not presentable does not occur.

In step S416, the control unit 101 determines whether or not the display of the virtual space can be controlled such that the touch corresponding to the haptic sensation that is not presentable does not occur. This determination is performed by using the haptic sensation reproduction signal acquired in step S403, the virtual object information acquired in step S404, and the like. In a case where the display of the virtual space can be controlled, the processing proceeds to step S418, and otherwise (in a case where the touch corresponding to the haptic sensation that is not presentable occurs even though the display of the virtual space can be controlled), the processing proceeds to step S417. Details of this determination will also be described later.

In step S417, the control unit 101 displays, as a predetermined notification, a warning indicating that a suitable haptic sensation corresponding to the touch with the virtual object cannot be obtained on the display unit 107. Note that, the notification in step S417 is not particularly limited, and for example, the notification may be performed by sound or the like instead of display.

In step S418, the control unit 101 controls the display of the virtual space. In addition, with the control of the display of the virtual space, the control unit 101 updates the estimated haptic sensation. In the first embodiment, the display of the virtual object touched by the user 10 (hand 11) is controlled. Details thereof will be described later. Note that, the control of the display of the virtual space is not limited to the control of the display of the virtual object touched by the hand 11. For example, another virtual object (heater or the like) or a display effect (snow or the like) that affects the haptic sensation may be added.

In step S419, the control unit 101 transmits a haptic sensation signal indicating the estimated haptic sensation for the user 10 (hand 11) to the haptic device 200 via the communication unit 103. In a case where the processing proceeds to step S418, a haptic sensation signal indicating the updated haptic sensation in step S418 is transmitted.

In step S420, the control unit 201 of the haptic device 200 controls the drive control unit 212 on the basis of the haptic sensation signal transmitted in step S419 to drive the haptic sensation generation unit 211 (haptics driver 213) to present the haptic sensation to the user 10 (hand 11).

In step S421, the control unit 101 and the control unit 201 determine whether or not to end the aerial haptics processing of FIG. 4. For example, when the connection between the display device 100 and the haptic device 200 is canceled by an instruction to turn off the power of the display device 100 or the haptic device 200 or an instruction to end the application that provides the virtual space to the user, the aerial haptics processing is ended. In a case where the aerial haptics processing is not ended, the processing proceeds to step S407.

A specific example of the processing (determination) in step S415 will be described.

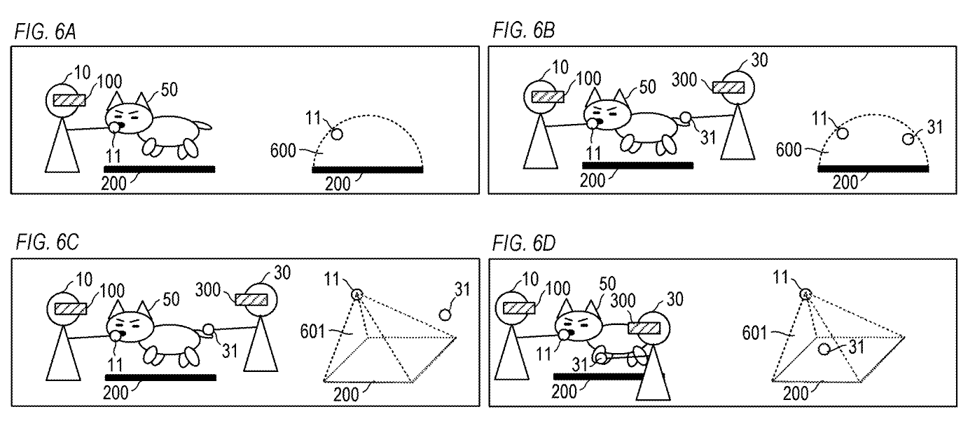

FIGS. 6A and 6B are schematic diagrams illustrating an example of processing in step S415. FIGS. 6A and 6B illustrate an example in which determination as to whether or not a predetermined number or more of user parts are included in a space on the basis of the information of the haptic device 200 is determined. In a case where the predetermined number or more of user parts are included in the space on the basis of the information of the haptic device 200, it is determined that the touch corresponding to the haptic sensation that is not presentable occurs, and otherwise, it is determined that the touch corresponding to the haptic sensation that is not presentable does not occur. The space on the basis of the information of the haptic device 200 may be a space indicated by the information, or may be a space set (determined) by the control unit 101 on the basis of the information. The space on the basis of the information of the haptic device 200 is, for example, a space on the basis of the haptic sensation reproduction signal, and is a space in which the haptic sensation is presentable from the haptic device 200 to the user. The predetermined number is not particularly limited, but it is assumed here that the predetermined number = 2.

In FIG. 6A, only the hand 11 of the user 10 is included in a space 600 on the basis of the information of the haptic device 200, and the number (1) of user parts included in the space 600 is smaller than the predetermined number (2). Thus, it is determined that the touch corresponding to the haptic sensation that is not presentable does not occur.

In FIG. 6B, the hand 11 of the user 10 and the hand 31 of the user 30 are included in the space 600, and the number (2) of user parts included in the space 600 is equal to the predetermined number (2). Thus, it is determined that the touch corresponding to the haptic sensation that is not presentable occurs.

FIGS. 6C and 6D are schematic diagrams illustrating another example of the processing in step S415. In FIGS. 6C and 6D, the control unit 101 sets a space including the hand 11 and the haptic device 200 on the basis of the position of the hand 11 of the user 10 and the position of the haptic device 200. Then, the control unit 101 determines whether or not the predetermined number or more of user parts are included in the set space. In a case where the predetermined number or more of user parts are included in the set space, it is determined that the touch corresponding to the haptic sensation that is not presentable occurs, and otherwise, it is determined that the touch corresponding to the haptic sensation that is not presentable does not occur. A method for setting the space including the hand 11 and the haptic device 200 is not particularly limited. Here, it is assumed that a conical space 601 having an output surface (surface that outputs the ultrasonic wave) of the haptic device 200 as a bottom surface and a position of the hand 11 as a vertex is set. In addition, the predetermined number is not particularly limited, but here, it is assumed that the predetermined number = 2.

In FIG. 6C, only the hand 11 of the user 10 is included in the space 601, and the number (1) of user parts included in the space 601 is smaller than the predetermined number (2). Thus, it is determined that the touch corresponding to the haptic sensation that is not presentable does not occur.

In FIG. 6B, the hand 11 of the user 10 and the hand 31 of the user 30 are included in the space 601, and the number (2) of user parts included in the space 601 is equal to the predetermined number (2). Thus, it is determined that the touch corresponding to the haptic sensation that is not presentable occurs.

Note that, the determination method in step S415 is not limited to the above method. For example, it may be determined whether or not the haptic sensation intensity estimated for the users 10 and 30 (hands 11 and 31) is within a predetermined range. The determination as to whether the haptic intensity is within the predetermined range may include determination as to whether the haptic intensity is equal to or greater than a threshold T1, may include determination as to whether the haptic intensity is equal to or less than a threshold T2 (> T1), or may include both of these determinations. The predetermined range is, for example, a range corresponding to an intensity range indicated by the haptic sensation reproduction signal (intensity range information).

Electromagnetic field analysis on the basis of the positions and orientations of the hands 11 and 31 and the position and orientation of the haptic device 200 is performed, and the result is compared with the haptic sensation estimated for the hands 11 and 31. As a result, it may be determined whether or not the touch corresponding to the haptic sensation that is not presentable occurs. Information (data) necessary for the determination may be output from the communication unit 103 to an external device (for example, a cloud server), the external device may perform the determination, and the determination result may be acquired from the external device. Information (for example, a table) indicating a correspondence relationship between the information necessary for the determination and the determination result may be prepared in advance, and a determination result corresponding to current information necessary for the determination may be acquired from the information indicating the correspondence relationship.

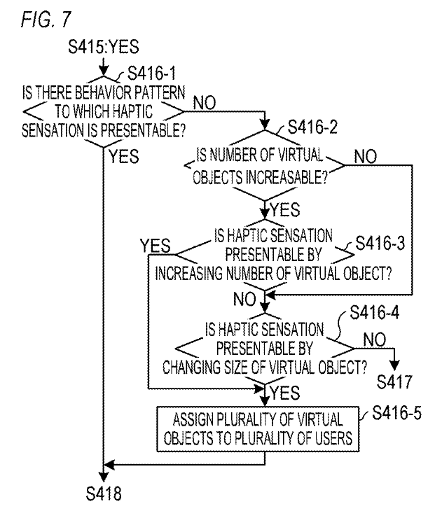

FIG. 7 is a flowchart of the processing (determination) in step S416.

In step S416-1, the control unit 101 determines whether or not there is a behavior pattern (position, orientation, or the like) of a virtual object that eliminates the touch corresponding to the haptic sensation that is not presentable on the basis of the virtual object information acquired in step S404. In a case where there is a behavior pattern, the processing proceeds to step S418 in FIG. 4, and otherwise, the processing proceeds to step S416-2. The behavior pattern for eliminating the touch corresponding to the haptic sensation that is not presentable may be interpreted as a behavior pattern in which the users 10 and 30 (hands 11 and 31) can obtain a suitable haptic sensation. In step S416-1, for example, determination similar to that in step S415 is performed for each of a plurality of behavior patterns without changing touch positions of the hands 11 and 31 with the virtual object, and thus, a behavior pattern that eliminates the touch corresponding to the haptic sensation that is not presentable is searched for.

In step S416-2, the control unit 101 determines whether or not the number of virtual objects can be increased. For example, the control unit 101 determines whether or not there is a space for adding a virtual object in a space on the basis of the haptic sensation reproduction signal acquired in step S403 (a space in which the haptic sensation is presentable to the user from the haptic device 200). In a case where the number of virtual objects can be increased (there is a space), the processing proceeds to step S416-3, and otherwise, the processing proceeds to step S416-4.

In step S416-3, the control unit 101 determines whether or not the touch corresponding to the haptic sensation that is not presentable can be eliminated by increasing the number of virtual objects. In a case where the touch can be eliminated, the processing proceeds to step S416-5, and otherwise, the processing proceeds to step S416-4. In step S416-3, for example, the determination similar to that in step S415 is repeatedly performed while changing the number of virtual objects without changing the touch positions of the hands 11 and 31 with the virtual object. As a result, a state (number, position, orientation, or the like of virtual objects) in which the touch corresponding to the haptic sensation that is not presentable is eliminated is searched for.

In step S416-4, the control unit 101 determines whether or not the touch corresponding to the haptic sensation that is not presentable can be eliminated by changing (enlarging or reducing) a size of the virtual object. In a case where the touch can be eliminated, the processing proceeds to step S416-5, and otherwise, the processing proceeds to step S417 in FIG. 4. Here, a case where the size of the virtual object is changed without increasing the number of virtual objects may be considered, or a case where the size of the virtual object is changed (reduced) to increase the number of virtual objects may be considered. In step S416-4, for example, the determination similar to that in step S415 is repeatedly performed while changing the size of the virtual object without changing the touch positions of the hands 11 and 31 with respect to the virtual object. As a result, a state (size, position, orientation, number, or the like of virtual objects) in which the touch corresponding to the haptic sensation that is not presentable is eliminated is searched for.

In a case where the touch corresponding to the haptic sensation that is not presentable can be eliminated by increasing the number of virtual objects, in step S416-5, the control unit 101 assigns each virtual object after the increase in the number to each user. Then, the processing proceeds to step S418 in FIG. 4. For example, in a case where one virtual object is increased to two virtual objects, the two virtual objects are assigned to two users 10 and 30. Under the control of step S418 in FIG. 4, each virtual object is displayed such that each user touches the virtual object assigned to the user. At this time, only the virtual object assigned to each user may be displayed on the display device of each user, or all the virtual objects after the increase in the number may be displayed.

A specific example of the processing in step S418 will be described. In step S418, the state of the virtual object is controlled to the state (size, position, orientation, number, or the like of virtual objects) found by the search in step S416. In addition, the estimated haptic sensation is updated accordingly.

In FIG. 5C, the user 10 touches the face of the dog 50 with the hand 11, and the user 30 touches the tail of the dog 50 with the hand 31. In this case, since the hand 11 and the hand 31 are separated from each other and a suitable haptic sensation is presentable to the hand 11 and the hand 31, the processing proceeds from step S415 to step S419 in FIG. 4. Then, the combined image (image in which the user 10 touches the face of the dog 50 with the hand 11 and the user 30 touches the tail of the dog 50 with the hand 31) in FIG. 5D is displayed on the display unit 107. At this time, the user 10 can obtain a haptic sensation touching the face of the dog 50, and the user 30 can obtain a haptic sensation touching the tail of the dog 50.

In FIG. 5E, the user 10 is touching the face of the dog 50 with the hand 11, and the user 30 is touching the forefoot of the dog 50 with the hand 31. In this case, since the hand 11, the hand 31, and the haptic device 200 are close to each other and a suitable haptic sensation is not presentable to the hand 11 and the hand 31, the processing proceeds from step S415 to step S416 in FIG. 4. Here, it is assumed that, in step S416, it is found by search that a suitable haptic sensation is presentable to the hand 11 and the hand 31 when the dog 50 lies down. In this case, in step S418, a state of the dog 50 is controlled such that the dog 50 lies down. As the dog 50 lies down, the user 10 moves the hand 11 to keep touching the face of the dog 50, and the user 30 moves the hand 31 to keep touching the forefoot of the dog 50. Then, the combined image (image in which the user 10 touches the face of the dog 50 with the hand 11 and the user 30 touches the forefoot of the dog 50 with the hand 31) in FIG. 5F is displayed on the display unit 107. At this time, the user 10 can obtain the haptic sensation touching the face of the dog 50, and the user 30 can obtain the haptic sensation touching the forefoot of the dog 50.

In the state of FIG. 5E, it is assumed that a behavior pattern of the dog 50 capable of presenting a suitable haptic sensation to the hand 11 and the hand 31 cannot be found even by searching and it is found by searching that a suitable haptic sensation is presentable to the hand 11 and the hand 31 when dogs 51 and 52 are displayed instead of the dog 50. In this case, in step S418, the state of the dog 50 is controlled such that the dogs 51 and 52 (both dogs are the same dogs as the dog 50) are displayed instead of the dog 50. The dogs 51 and 52 displayed, and thus, the user 10 moves the hand 11 to keep touching the face of the dog 50, and the user 30 moves the hand 31 to keep touching the forefoot of the dog 50. Then, the combined image (image in which the user 10 touches the face of the dog 51 with the hand 11 and the user 30 touches the forefoot of the dog 52 with the hand 31) in FIG. 5G is displayed on the display unit 107. At this time, the user 10 can obtain a haptic sensation touching the face of the dog 51 (dog 50), and the user 30 can obtain a haptic sensation touching the forefoot of the dog 52 (dog 50).

According to the first embodiment, the display of the virtual space is controlled such that, as touches of two or more users with the virtual object in the virtual space, touches corresponding to haptic sensations that are not simultaneously presentable to two or more users from a haptic device to be used do not occur. As a result, it is possible to suppress presentation of a haptic sensation with a sense of discomfort.

### Second Embodiment

A second embodiment of the present disclosure will be described. In the second embodiment, information of a prediction result of future position and orientation of the user is acquired as the information of the position and orientation of the user. Note that, hereinafter, description of configurations and processing similar to those of the first embodiment will be omitted, and configurations and processing different from those of the first embodiment will be described.

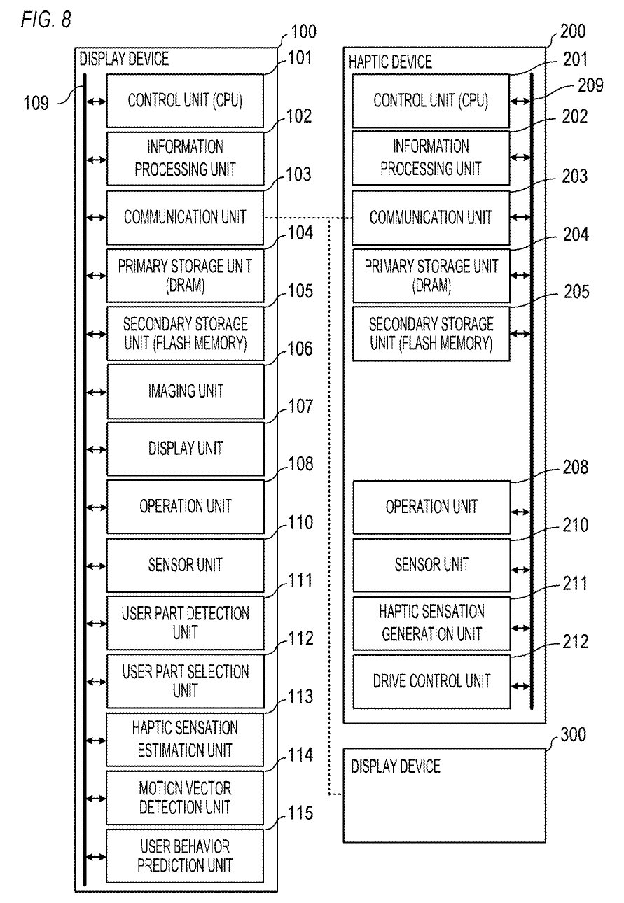

FIG. 8 is a block diagram illustrating a configuration of a display system according to the second embodiment. In the display system of FIG. 8, a display device 100 includes the plurality of components illustrated in FIG. 1, a motion vector detection unit 114, and a user behavior prediction unit 115.

The motion vector detection unit 114 detects feature points of an image from image data of a current frame obtained by the imaging unit 106, and detects motion vectors of feature points from a past frame (for example, a previous frame of a current frame) to the current frame. Three-dimensional coordinates of the feature points are acquired, and a three-dimensional motion vector is acquired. A method for detecting the motion vector is not particularly limited, and the motion vector may be detected by a known method such as a correlation method or a block matching method.

The user behavior prediction unit 115 predicts a future behavior of the user on the basis of the behavior of the user up to the present. The behavior of the user may be interpreted as a temporal change in the position and orientation of the user part. A method for predicting the behavior of the user is not particularly limited. In the second embodiment, the user behavior prediction unit 115 predicts a position, an orientation, and a speed of the user part in a future frame on the basis of the pieces of information acquired by the user part detection unit 111, the motion vector detection unit 114, and the sensor unit 110. The future frame is, for example, a frame next to the current frame. In the second embodiment, it is assumed that the imaging unit 106 is fixed to the display device 100. Thus, the motion vector detected by the motion vector detection unit 114 indicates a relative motion with respect to the display device 100. The user behavior prediction unit 115 excludes a translation component and a rotation component of the display device 100 from the motion vector detected by the motion vector detection unit 114 on the basis of the angular velocity and the current position of the display device 100 acquired by the sensor unit 110. As a result, the speed of the user part is acquired. The user behavior prediction unit 115 predicts a position, an orientation, and a speed of the user part in the future frame on the basis of the acquired speed of the user part and the position and orientation of the user part detected by the user part detection unit 111.

Note that, the motion vector detection unit 114 may detect a temporal change of the motion vector up to the present such that the user behavior prediction unit 115 considers a more detailed behavior as the behavior of the user up to the present. The user behavior prediction unit 115 may predict the behavior of the user in a period for a plurality of future frames. At that time, a prediction result for a first frame that is a future frame may be used for prediction for a second frame after the first frame.

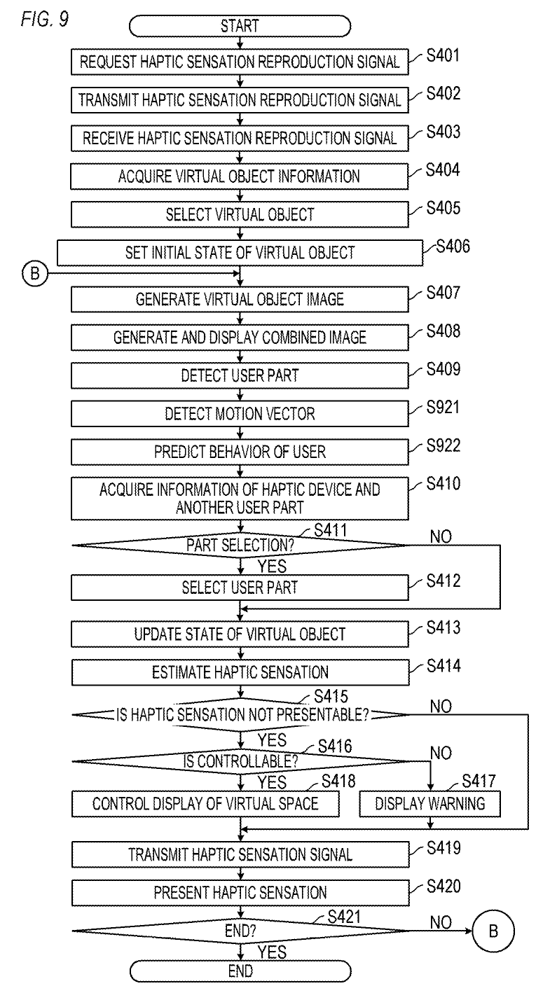

FIG. 9 is a flowchart of aerial haptics processing performed by the display system according to the second embodiment.

As in the first embodiment (FIG. 4), the processing in steps S401 to S409 is performed.

In step S921, the control unit 101 controls the motion vector detection unit 114 to detect the motion vector of the feature points from the image obtained by the imaging unit 106 (the real space image obtained by imaging the real space).

In step S922, the control unit 101 controls the user behavior prediction unit 115 to predict the position, orientation, and speed of the hand 11 of the user 10 in the future frame. For the prediction, the position and orientation of the hand 11 detected in step S409, the motion vector detected in step S921, and the angular velocity and the current position of the display device 100 acquired by the sensor unit 110 are used.

As in the first embodiment (FIG. 4), the processing in steps S410 to S420 is performed. However, the prediction result of step S922 is used as the position and orientation of the hand 11 of the user 10.

According to the second embodiment, processing similar to that of the first embodiment is performed by using information of the future position and orientation of the user. As a result, it is possible to prevent the touch corresponding to the haptic sensation that is not presentable.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

Although the example in which the present disclosure is applied to the display device has been described, the information processing apparatus to which the present disclosure is applicable is not limited to the display device. For example, the present disclosure is also applicable to a personal computer or the like connected to the display device. In addition, the information processing apparatus to which the present disclosure is applied may acquire various types of data and information (for example, information of the position and orientation of the user part) which are assumed to be generated in the display device 100 from the outside.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-216248, filed December 11, 2024, which is hereby incorporated by reference herein in its entirety.

What is claimed is:

1. An information processing apparatus comprising:
a processor; and
a memory storing a program which, when executed by the processor, causes the information processing apparatus to
execute acquisition processing of acquiring information of a position and an orientation of a user for each of a plurality of users, and
execute control processing of controlling display of a virtual space on a basis of a plurality of information respectively corresponding to the plurality of users acquired by the acquisition processing such that touches corresponding to haptic sensations that are not simultaneously presentable to two or more users from a haptic device to be used do not occur as the touches of the two or more users with a virtual object in the virtual space.

2. The information processing apparatus according to claim 1,
wherein a position and an orientation of the user in the virtual space are linked to a position and an orientation of the user in a real space, and
in the acquisition processing, a first user among the plurality of users is detected from the real space, and information of a position and an orientation of the first user is acquired.

3. The information processing apparatus according to claim 2,
wherein, in the acquisition processing, the first user is detected from an image obtained by imaging the real space.

4. The information processing apparatus according to claim 2,
wherein, in the acquisition processing, information of a position and an orientation of a second user different from the first user among the plurality of users is acquired from an outside of the information processing apparatus.

5. The information processing apparatus according to claim 2,
wherein the information of the position and the orientation of the user is information of a position and an orientation of a part of the user,
a plurality of parts of the first user are detected in the acquisition processing,
the program, when executed by the processor, further causes the information processing apparatus to execute selection processing of selecting at least one of the plurality of parts of the first user, and
in the control processing, information of a position and an orientation of a part selected by the selection processing is used as the information of the position and the orientation of the first user.

6. The information processing apparatus according to claim 1,
wherein the information of the position and the orientation of the user is information of a position and an orientation of a part of the user, and
in the control processing, a space including a part of a first user among the plurality of users and the haptic device is set, and the display of the virtual space is controlled such that a predetermined number or more of parts of users are not included in the set space.

7. The information processing apparatus according to claim 1,
wherein the information of the position and the orientation of the user is information of a position and an orientation of a part of the user,
in the acquisition processing, information of the haptic device is further acquired, and
in the control processing, the display of the virtual space is controlled such that a predetermined number or more of parts of users are not included in a space on a basis of the information of the haptic device.

8. The information processing apparatus according to claim 7,
wherein a space on a basis of the information of the haptic device is a space in which a haptic sensation is presentable from the haptic device to the user.

9. The information processing apparatus according to claim 1,
wherein, in the acquisition processing, information of a prediction result of future position and orientation of the user is acquired as the information of the position and orientation of the user.

10. The information processing apparatus according to claim 1,
wherein, in the control processing, at least one of a position and an orientation of the virtual object is controlled.

11. The information processing apparatus according to claim 1,
wherein, in the control processing, a number of virtual objects is controlled.

12. The information processing apparatus according to claim 1,
wherein, in the control processing, a size of the virtual object is controlled.

13. The information processing apparatus according to claim 1,
wherein, in the control processing, in a case where the display of the virtual space is not controllable such that the touch corresponding to the haptic sensation that is not presentable does not occur, control is performed to perform a predetermined notification.

14. An information processing method comprising:
processing of acquiring information of a position and an orientation of a user for each of a plurality of users; and
controlling display of a virtual space on a basis of a plurality of acquired information respectively corresponding to the plurality of users such that touches corresponding to haptic sensations that are not simultaneously presentable to two or more users from a haptic device to be used do not occur as the touches of the two or more users with a virtual object in the virtual space.

15. A non-transitory computer readable medium that stores a program, wherein the program causes a computer to execute an information processing method comprising:
processing of acquiring information of a position and an orientation of a user for each of a plurality of users; and
controlling display of a virtual space on a basis of a plurality of acquired information respectively corresponding to the plurality of users such that touches corresponding to haptic sensations that are not simultaneously presentable to two or more users from a haptic device to be used do not occur as the touches of the two or more users with a virtual object in the virtual space.
